(19) United States
(12) Patent Application Publication
(10) Pub. No.: US 2013/0226691 A1
(43) Pub. Date: Aug. 29, 2013

(54) MULTI-CHANNEL CAMPAIGN PLANNING

(71) Applicants: Ehud Chatow, Palo Alto, CA (US); Zainab Jamal, Palo Alto, CA (US); Kay-Yut Chen, Santa Clara, CA (US)

(72) Inventors: Ehud Chatow, Palo Alto, CA (US); Zainab Jamal, Palo Alto, CA (US); Kay-Yut Chen, Santa Clara, CA (US)

(21) Appl. No.: 13/405,225

(22) Filed: Feb. 24, 2012

(51) Int. Cl. G06Q 30/02

(52) U.S. Cl. 705/14.42; 705/14.49

(57) ABSTRACT

A computer system for multi-channel campaign planning includes a digital processor, and computer readable instructions to plan and manage a multi-channel campaign. The instructions are embedded on a non-transitory, tangible memory device and executable by the processor. The instructions include a scenario outcome predicting module to predict an outcome for a scenario having a set of parameters defined for each channel of a phase of a plurality of iterative phases of the multi-channel campaign. The instructions include an adaptive learning module to generate an optimized learning component of the multi-channel campaign. The instructions include a decision optimization module to optimize the multi-channel campaign over the plurality of iterative phases. The instructions include a campaign execution module to execute the multi-channel campaign and collect outcome data. An initial phase of the plurality of phases is executed without prior outcome data for the scenario of the initial phase.

### BACKGROUND

Targeted marketing is often utilized to promote products and/or services to a particular group of prospective customers, donors, etc. Targeted marketing may involve generating campaigns (e.g., awareness campaigns, call-to-action campaigns, etc.) that include specific information and/or questions, product and/or service offerings, promotions, donation requests, or the like. One goal of targeted marketing is to customize a message for the particular group of prospective customers, donors, etc. in a manner that is focused to the particular group.

### BRIEF DESCRIPTION OF THE DRAWING

Features and advantages of examples of the present disclosure will become apparent by reference to the following detailed description and drawing.

FIG. 1 is a schematic diagram of an example of the computer system for multi-campaign planning.

### DETAILED DESCRIPTION

The present disclosure relates generally to multi-channel campaign planning.

The method and system disclosed herein may be used to optimize campaigns quickly and efficiently utilizing minimal information at the outset of the campaign. Examples of the method and system utilize iterative learning cycles to optimize the campaign in a relatively short amount of time (e.g., two months or less in some instances). In some instances, optimization is initiated based on simulation and benchmark machine readable instructions, and over time, optimization incorporates almost real-time campaign outcome data that is analyzed and used to define subsequent iterations of the campaigns, thereby accelerating convergence to an optimized campaign.

The campaigns disclosed herein are multi-channel campaigns, meaning that multiple delivery channels may be used to transmit the campaign material(s) to the desired recipient. The system 10 is based upon closed loop metrics, so it is desirable that whichever channel(s) is/are selected, the responses to the campaign can be measured. Suitable delivery channels include print (e.g., flyers, mailers, faxes, consumer in-house distributed printing, printouts, etc.) and non-print (e.g., electronic messages including: Instant messages, Personal messages, Text messages, SMTP messages, Email, Voicemail, Pager messages, electronic bulletin board system postings, Internet forum postings, Internet Newsgroup items, etc.). In some instances, interactive media may also be used as a channel, as long as the recipient responses can be measured. For example, an Interactive television advertisement that calls for action on the part of the viewer may be utilized in a campaign. As an example, the system disclosed herein is able to manage a campaign which includes both print communications and non-print communications. The method and system disclosed herein enable an optimized campaign to be delivered via the desired multiple channels while complying with campaign owner constraints (e.g., time line, budget, etc.).

The campaigns may be awareness campaigns or call-to-action campaigns. Awareness campaigns are generally informative campaigns that disseminate a desired message to the recipient (e.g., drug awareness, political awareness, new product awareness, etc.) or create brand awareness (e.g., brand sponsoring of activities or events) where the tracked responses can be created by enabling a linked video for more dynamic information with the mobile scan. Call-to-action campaigns are generally campaigns that ask the recipient to do, or refrain from doing some action (i.e., purchase, donate, answer survey or poll questions, vote, call a government official, etc.). The campaign may be any campaign where responses of recipients can be tracked. In some instances, the campaigns are both awareness and call-to-action campaigns.

The campaigns disclosed herein include multiple phases. Any phase of a campaign involves planning an optimal deployment campaign for the particular phase, execution of the optimal deployment campaign for the particular phase, and receiving outcome data for the executed optimal deployment campaign. Subsequent phases may build upon information received in response to one or more earlier phases.

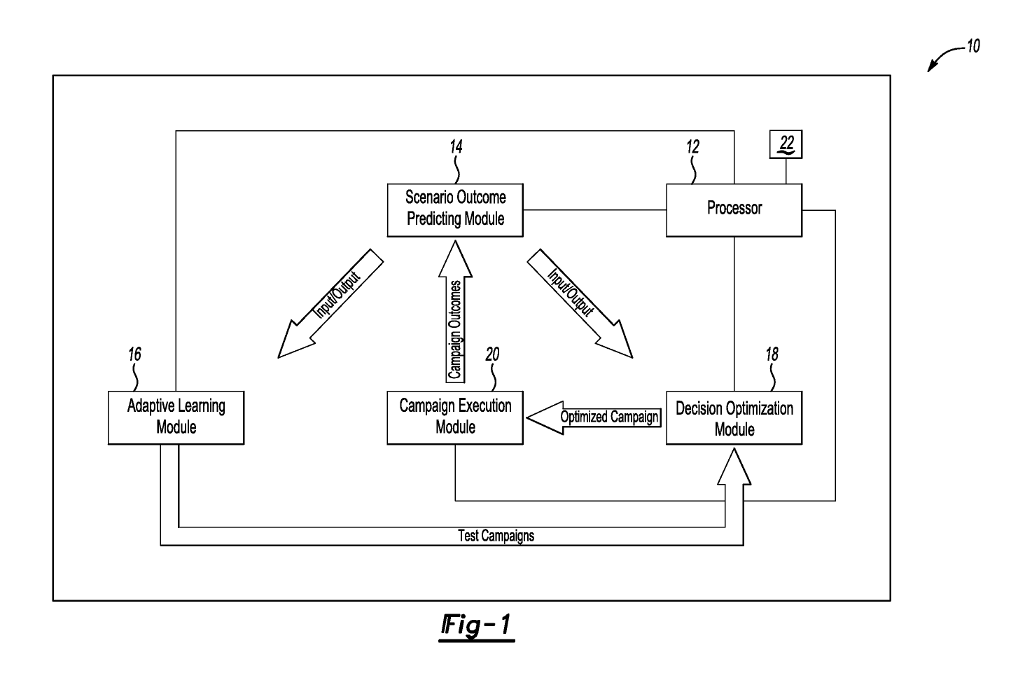

Referring now to FIG. 1, an example of the multi-channel campaign planning system 10 is illustrated. The system 10 includes a digital processor 12 that is capable of executing the computer readable instructions to plan and manage a multi-channel campaign. The computer readable instructions include a scenario outcome predicting module 14, an adaptive learning module 16, a decision optimization module 18, and a campaign execution module 20.

The processor 12 may include the hardware architecture for retrieving executable code (i.e., the computer or machine readable instructions) from a memory device, and executing the executable code. The executable code may, when executed by the processor 12, cause the processor 12 to implement at least the functionalities of generating optimal deployment campaigns and iteratively updating and changing the campaigns. In the course of executing code, the processor 12 may receive input from and provide output to a number of system hardware units. While not shown, it is to be understood that the various hardware components of the system 10 may be in communication via a bus.

The memory device(s) that store the executable code may include various types of memory modules, including volatile and nonvolatile memory. As an example, the memory device(s) may include Random Access Memory (RAM), Read Only Memory (ROM), and Hard Disk Drive (HDD) memory. It is believed that other types of memory may also be used. In some instances, different types of memory may be used for different data storage needs. For example, the processor 12 may boot from Read Only Memory (ROM), maintain nonvolatile storage in the Hard Disk Drive (HDD) memory, and execute program code stored in Random Access Memory (RAM). Generally, the memory device(s) are non-transitory, tangible computer readable storage media. For example, the memory device(s) may be an electronic, magnetic, optical, electromagnetic, infrared, or semiconductor system, apparatus, or device, or any suitable combination thereof. More specific examples of the computer readable storage medium may include, for example, the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination thereof.

While not shown, the system 10 may also include peripheral device adapters that provide an interface to input device and output devices to create a user interface and/or access external sources of memory storage. An input device (e.g., keyboard or keypad, mouse, touchscreen, etc.) may be provided to allow a user to interact with the system 10. The peripheral device adapter may also create an interface between the processor 12 and a printer, a display device, or another output device.

The system 10 may be part of a stand-alone server or workstation that is owned and/or operated by a brand owner or a market campaign manager. Alternatively, the system 10 may be part of a cloud computing system. When part of a cloud computing system, the system 10 may be owned and/or operated, e.g., by a print service provider who offers campaign managing as a service to its clients. The “cloud” is a computer network accessible over the Internet and/or web that is dynamically scalable with virtualized resources, such as printing resources. In an example, the cloud may or may not be physically distributed. The user of the system 10 is not required to have knowledge or expertise in the infrastructure of the cloud that relies on the Internet to satisfy his/her campaign managing needs. The cloud provides the services of the system 10 that are accessible from a web browser while computer readable instructions and data are stored on servers in the cloud.

The various modules 14, 16, 18, and 20 are programmed to work independently and together to optimize multi-channel campaigns. Each of the modules 14, 16, 18, and 20 is able to automatically communicate with other modules 14, 16, 18, and 20 without being prompted by a user. The modules 14, 16, 18, and 20 are programmed to automatically generate and execute a campaign with minimal user instruction, as will be described herein. Each of the modules 14, 16, 18, and 20 will now be described, and then an example of the method will be described to illustrate the functionality of the modules 14, 16, 18, and 20, both alone and in combination.

The scenario outcome predicting module 14 provides backend modeling for the system 10. This module 14 tracks and analyzes information related to a campaign in order to produce comparative and predictive analytics/metrics. In an example, the scenario outcome predicting module 14 is based on consumer response modeling, and can predict consumer responses.

The modeling performed by the scenario outcome predicting module 14 may be based upon a set of parameters, which may vary depending, at least in part, upon which iterative phase of the campaign is being analyzed and what information is available. In an example, the scenario outcome predicting module 14 automatically selects the parameters that are utilized. In another example, a user of the system 10 may be allowed to select the parameters (e.g., from a drop down menu) to create his/her own template for the modeling that is performed.

The set of parameters may include demographic information, socio- economic information, market information, product and/or service information, outcome data from previous phase(s) of the campaign, recipient behavior information, product usage information, a sub-sample description (i.e., a summary of a target recipient in a given phase of a given campaign), attributes of previous phase(s) of the campaign, or combinations thereof. For an initial phase of a campaign, the set of parameters may be more limited than for subsequent phases of the same campaign. In an example, the parameters of the initial phase include any of the above listed parameters except, for example, outcome data from previous phase(s) of the campaign, recipient behavior information, product usage information, a sub-sample description (i.e., a summary of a target recipient in a given phase of a given campaign), and attributes of previous phase(s) of the campaign. For subsequent phases of any campaign, any combination of the previously listed parameters may be utilized, and in many instances the parameters that involve previous campaign information will be used.

The information associated with a particular parameter may be user- supplied information, product usage information, past experience information, and/or outcome data (i.e., recipient specific responses). User supplied information is information received by the scenario outcome predicting module 14 from a user of the system. As mentioned above, the system 10 includes an input device. This allows a user to input information, such as a budget, a timeline, campaign objectives (e.g., type/purpose, theme, style, design, desired size, etc.), intended audiences (e.g., potential new customers, voters of a particular party, etc.), intended audience demographic and socio-economic information (e.g., zip code, income, education, gender, age, etc.), or the like, or combinations thereof.

Product usage information includes data related to recency of usage, frequency of usage, and amount of usage. For purchase-related campaigns, this information may be related to when the product was last purchased, how many times a target recipient or group of recipients has purchased the product in the past, and the monetary value of past purchases. For non-purchase-related campaigns (e.g., application downloads, picture uploads or sharing, etc.), this information may be related to the recency of usage, frequency of usage, and intensity or amount of usage.

Past experience information may be supplied by the user or may be generated and stored automatically by the scenario outcome predicting module 14. When a new user is initiating a campaign using the system 10, but has information from previous campaigns he/she has run, he/she may input such information into the system 10. Alternatively, after a campaign has been initiated using the system 10, the scenario outcome predicting module 14 will store any information related to a particular campaign. The received and/or stored information may be used by the scenario outcome predicting module 14 as past experience information when subsequent phases of the campaign are run, or when a new, but related campaign is initiated.

Past experience information may include recipient past behavior information. Examples of recipient past behavior information includes number of purchases, number of clicks on a website associated with a product and/or service, number of pages visited on a website associated with a product and/or service, time spent on a website associated with a product and/or service, or combinations thereof. Past experience information may also relate to market and/or product information. This information may include, for example, characteristics of the industry of the product and/or service being promoted, such as whether the product/service category is new or emerging, whether the product/service category is mature and established, the number of competitors in the industry, the intensity of promotions within the industry, the seasonality of the products/services, or combinations thereof. Still further, past experience information may relate to attributes of a previously executed campaign. Examples of campaign attributes may include when the campaign was sent, the duration of the campaign, main offerings or information provided in the campaign, the theme of the campaign, the size of the campaign (i.e., how many recipients were targeted), targeting criteria of the campaign (e.g., new customers, existing customers, customers that purchased more than one year ago, etc.) or combinations thereof.

Outcome data includes characterization of actual recipient activity in response to an executed campaign or an executed phase of a campaign. The characterization may include a count, a summation, a categorization, an aggregation, a statistical model, a mathematical model and combinations thereof. Outcome data may also be a characterization of recipient activity in response to past campaigns. Outcome data may include, for example, a frequency of emails opened, a count of clicks made on a website to view products/services, a number and/or value of purchases or a monetary value of donations linked to a campaign, responses to a survey or poll, number attending an event, or any other recipient response activity that is tracked.

The scenario outcome predicting module 14 receives at least information about a user's budget and one or more campaign objectives. With this information, either alone or in combination with other available information, the scenario outcome predicting module 14 generates a scenario and a predicted outcome for the scenario for each channel to be used in this phase of the campaign. For example, the scenario outcome predicting module 14 may receive a user's budget, the user's industry, and the user's campaign objectives. For example, a campaign objective may be to obtain new customers within a target age group of 20-30 year olds and a particular geographic area. With this information, the scenario outcome predicting module 14 will generate a scenario and a predicted outcome for different channels that may be part of the campaign. As examples, one scenario may involve an email channel with a 10% discount and bright colors that is sent to the target audience in more affluent neighborhoods of the geographic area and the associated predicted outcome of the email part may be 1% response rate, and another scenario may involve a print channel (e.g., a flier, mailer, etc.) with a 40% discount and bright colors that is sent to the target audience in less affluent neighborhoods of the geographic area and the predicted outcome of the print part may be 5% response rate.

To generate the scenario(s) and predicted outcome(s), the scenario outcome predicting module 14 uses statistical and time series modeling techniques, such as vector autoregressive models, dynamic linear models, customer choice models, and/or survival models. The output of the modeling is the predicted recipient responses to the given campaign utilizing the given channel. The output may include metric(s) that are generated by the module 14. Examples of metrics include any measurable characterization of outcome data: return on investment (ROI), adoption rates, click-through rates (e.g., for scenarios involving email), purchase rates, comparisons across campaigns (e.g., when data for other similar campaigns is available), comparisons with benchmark rates, comparisons across marketing channels, and combinations thereof.

The adaptive learning module 16 generates test-marketing campaigns that are designed to maximize learning from the responses that will be generated by the recipients. The adaptive learning module 16 receives the output from the scenario outcome predicting module 14, including accuracies and confidence intervals associated with the predicted customer responses and any associated predicted metrics. The adaptive learning module 16 analyzes the information and generates a plurality of test campaigns for each channel.

Each of the test campaigns includes an optimized learning component. The optimized learning component may be particular to each test campaign, and is designed to maximize the learning efficiency of the particular test campaign. The learning efficiency may be defined as the amount of expected information to be obtained, as measured by information theory metrics (e.g., information entropy) or other business metrics (e.g., the accuracy of the predicted recipient responses). Information economics combined with intertemporal optimization and dynamic programming are used to give the optimized learning component leveraged applicability in an iterative campaign. In an example, the adaptive learning module 16 optimizes the test market so that any data received (in response to the campaign) helps with information gathering, which may be useful for subsequent iterations/phases of the campaign.

With each test campaign, the adaptive learning module 16 outputs specifics for information gathering. Examples of outputs of the adaptive learning module 16 include: sub-sample determination (e.g., testing a campaign in groups A and B), experimental design (e.g., different marketing drivers allocated to different sub-samples), and allocation of marketing drivers as design factors. Such marketing drivers may include channel, incentive, specific message, timing and sequence of marketing action. When making a sub-sample determination, the adaptive learning module 16 determines that in order to maximize information gathering from any received responses, it may be beneficial to run one test campaign with different recipient segments (i.e., sub-samples). Utilizing sub-samples of targeted recipients enables any responses received from the different groups to be categorized differently and analyzed separately. This enables the system 10 to determine whether the same test campaign was received more favorably by a particular group. The responses from sub-samples may also suggest to the system 10 where the cutoff should be as to how many recipients should be in each group and included per campaign so as to best meet the targets as defined for the campaign.

It is to be understood that a relatively small portion of budgeted campaign resources may be allocated to learning components, thereby reserving more of the budgeted campaign resources for iterations of the campaign that are closer to convergence and optimization. In these examples, the adaptive learning module 16 is programmed to generate a test campaign that maximizes learning utilizing test devices. In a single-channel portion of an example, the learning component of an initial email coupon campaign may include the test devices. To further illustrate, 50 email coupons may be sent in each of 10 different fonts to a diverse population. If only 20% of the recipients respond by redeeming the coupons, but the largest font had the largest response, a subsequent email coupon campaign iteration may include only the largest font. The subsequent campaign iteration may include 5,000-50,000 email coupons in a font that has been proven to be more effective.

The decision optimization module 18 determines the optimal campaign (i.e., an optimal campaign to be deployed or an optimal deployment campaign), based on existing data and modeling. The optimal campaign may, for example, maximize a business objective including profit, revenue, market share and combinations thereof. It is to be understood that optimization of a business objective may include minimizing the objective, for example, minimizing a cost (e.g., campaign fulfillment, i.e., start to finish, cost). In addition to optimizing the business objective, the decision optimization module 18 may mitigate a trade-off between using an information gathering campaign (output of the adaptive learning module 16) and a campaign that uses the acquired information to optimize the business objective.

Thus, the decision optimization module 18 determines whether it is better (based on some forward-looking criterion) to use an “information gathering” campaign, a “business optimized” campaign, or combinations thereof. The forward-looking criterion that may be considered include information entropy (i.e., with a goal of reducing entropy) and out-sample predictability of recipient responses (i.e., with a goal to reduce the error in response predictions). The decision optimization module 18 mitigates a trade-off between three types of business objectives: revenue maximization, profit maximization, costs minimization, return on investment maximization, and information gathering. In other words, the decision optimization module 18 calculates an optimum combination of revenue and/or profit maximization, cost minimization, and information gathering.

Further, the decision optimization module 18 may be a gate keeper for the adaptive learning module 16. In an example, the decision optimization module 18 determines which of the test campaigns from the adaptive learning module 16 is most suitable for the then-current objectives, set of parameters, etc. In another example, the decision optimization module 18 determines that some aspects of one test campaign should be combined with some aspects of another test campaign to develop the optimal campaign.

The outputs of both the scenario outcome predicting module 14 and the adaptive learning module 16 are inputs to the decision optimization module 18.

The decision optimization module 18 applies optimization, stochastic modeling, stochastic optimization, and dynamic programming to the inputs, thereby rendering specifics of a recommended campaign as output. Some examples of the optimization methods that may be integrated into the decision optimization module 18 include small and large scale linear-programming, integer programming, mixed integer programming, constraint programming, heuristic programming based on specific problem structures, etc.

Some of the particular factors included in the recommend campaign may be marketing drivers, including channel, incentive, specific message, timing and sequence of marketing action. In other words, the decision optimization module 18 may determine dimensions of offering(s) in a campaign, expected profits of a campaign, an expected return on investment, an expected market share, or the like. For example, the decision optimization module 18 may determine “what” to offer (incentive and message determination), “who” to extend an offer or other material to (market segment and individually optimized offerings/materials), “where” to offer (geographical region to offer to), “how” to offer (through what channel(s)), and “when” to offer (the timing and sequences of offers). When determining who to send an offer or material to, the decision optimization module 18 may also determine how many recipients to send the offer or material to for the sampling size (e.g., to optimize learning) and/or for an optimal return on investment. When defining the optimal deployment campaign, the decision optimization module 18 may also take into account any constraints input by the user (e.g., budget, number of recipients, etc.).

In a second iteration of a campaign (i.e., an initial iteration has been sent out and outcome data has been received), for example, the optimized parameters may include which version of the printed campaign should continue based on previous results for a selected customer segment based on email response statistics. The decision optimization module 18 may optimize the timing and sequence of email communication relative to printed material sent and responses or conversions received. The analytics and fast turnaround for campaign optimization during the campaign period is enabled by the system 10 and method disclosed herein. It is easy to get started and easy to scale with the campaign management solution as described in the present disclosure.

The campaign execution module 20 executes the campaign according to the output of the decision optimization module 18. For example, the campaign execution module 20 may generate and send emails, print (e.g., directly to a web-enabled printer or through a Print Service Provider) and send printed material, deliver voice mail, make bulletin board postings, update websites, generate interactive television ads, etc. The campaign execution module 20 may collect outcome data for input to the scenario outcome predicting module 14 for initial preparation of the next phase of the campaign.

The system 10 may also include a database 22 that is dynamically generated as campaigns are created and deployed/run. The information that populates the database is based upon the learning that takes place throughout the respective phases of a campaign. The database 22 may receive learned information from any of the modules 14, 16, 18, 20 through the processor 12. The information may be stored according to individual campaigns and/or clients, or the information may be stored in any other organized fashion. The information stored may be information input by a user, information about deployed campaigns at various phases, received responses from deployed campaigns, information gained in the adaptive learning and test campaign process, and/or any other information that is gained throughout the campaign generation process. As such, the database 22 may contain data, analytical information, and real world information.

The information stored in the database 22 may be used for the creation of other campaigns or for other purposes. For example, if a new user of the system 10 has no information other than his/her budget and business objectives, the system 10 may access the database 22 for information previously stored therein to expand the parameters used by the scenario outcome predicting module 14 when initiating a new campaign for the new user. In this particular example, the database 22 has been built up over time with information from other campaigns, and database 22 may be searched, using keywords indicative of the new user's business objectives.

The following is an example of the method which utilizes the system 10 to generate iterative phases of a campaign. At the outset, a user inputs starting information. In this particular example, the user has no previous campaign information, statistics, or feedback. The user may input the following information: that he has a budget of $10,000; that he is looking to sell a new cosmetic line (including foundation, bronzer, mascara, etc.); that he has a website for the cosmetic line; and that he has no geographical boundary. This information is received by the scenario outcome predicting module 14, which uses the information to generate three scenarios and associated predicted outcomes. One scenario involves an email sent to a nation-wide audience with a 10% coupon, the second scenario involves a printed invitation sent to a very small target audience to a private showing of the products at a mall located near the user, and the third scenario involves a printed 5% off coupon sent to a target audience within the user's home city, where the printed coupon notes the local roots of the user in an attempt to personalize the user to the target audience. The scenario outcome predicting module 14 also generates the predicted outcomes, e.g., 6% success for the first scenario, 10% success for the second scenario, and 8% success for the third scenario.

The scenarios and associated predicted outcomes are sent to the adaptive learning module 16, which takes the information and generates multiple test campaigns for each of the channels identified by the scenario outcome predicting module 14. The test campaigns are designed to maximize learning. For example, one test campaign may involve offering the same discount for the cosmetics to two different ethnic groups (i.e., sub-samples), and targeting the look and message of the respective offerings to the different ethnic groups. Another test campaign may involve custom made printed invitations to an invite-only preview to try the cosmetics, where the invitations are made with card stock and calligraphy. A 15% discount is offered for the invitee if he/she fills out a questionnaire at the event. Still a third test campaign may be a printed mailer with e-coupons for various cosmetic products.

The outputs of both the scenario outcome predicting module 14 and the adaptive learning module 16 are inputs to the decision optimization module 18. The decision optimization module 18 utilizes this information to select or generate an optimal deployment campaign for the user. In this example, the decision optimization module 18 may determine to offer a 15% discount in the form of mailed and emailed coupons to a target audience of woman aged range from 15 to 55 within the user's city. The decision optimization module 18 may also determine that the initial phase of the campaign should run with two different theme colors, e.g., pink for one theme and red for the other theme. Still further, the decision optimization module 18 may also determine that the initial phase of the campaign should run with two different highlighted products, where the campaign highlights a leading product of interest for one user segment and highlights another leading product of interest for the another user segment. For example, a foundation may be highlighted in the campaign for 30-55 year old women, and a bronzer may be highlighted in the campaign for 15-29 year old women.

The campaign execution module 20 executes the campaign selected or generated by the decision optimization module 18.

In this example, one month after the initial phase of the campaign is initiated, the outcome data indicates that i) 10% of the woman receiving the emailed coupon visited the user's website and 4% purchased some cosmetics, where 6% of the 10% received the pink themed information ii) 5% of the printed coupons have been redeemed, where 4% of the redeemed coupons had the pink theme, iii) 75% of the woman purchasing cosmetics are in the age range of 20 to 40, and iv) 50% of purchasers purchased the bronzer. The various modules 14, 16, 18, 20 of the system 10 may utilize the original information and the outcome data to design the second iteration or phase of the campaign. In this process, the system 10 may arrive at another optimal deployment campaign that targets woman between the ages of 20 and 40 with both a print coupon and an emailed coupon having a pink theme (i.e., the more successful theme from the initial phase of the campaign) and highlighting the bronzer (i.e., the better performing product from the initial phase of the campaign). After multiple iterations, the campaign may be altered, for example, regarding the timing of when the coupons are sent, the type of offer that is provided (e.g., discount, but one get one ½ off, etc.).

It is to be understood that the cycle time between different campaign phases may vary, depending upon the channel used, the response required, any expirations that are put on an offer in the then-current phase of the campaign, etc. In some instance, a cycle time between iterations/phases of a campaign may range from 1 hour to 4 weeks, or longer in some instances. As such, campaign optimization utilizing the system 10 disclosed herein is close to real time, at least in part because subsequent phase generation may take place as soon as a desired number of responses are tracked/received.

While several examples have been described in detail, it will be apparent to those skilled in the art that the disclosed examples may be modified. Therefore, the foregoing description is to be considered non-limiting.

What is claimed is:

1. A computer system for multi-channel campaign planning, comprising:
a digital processor; and
computer readable instructions embedded on a non-transitory, tangible memory device, the instructions being executable by the digital processor, the instructions to plan and manage a multi-channel campaign including:
a scenario outcome predicting module to predict an outcome for a scenario having a set of parameters defined for each channel of a phase of a plurality of iterative phases of the multi-channel campaign;
an adaptive learning module to generate an optimized learning component of the multi-channel campaign;
a decision optimization module to optimize the multi-channel campaign over the plurality of iterative phases; and
a campaign execution module to execute the multi-channel campaign and collect outcome data, wherein an initial phase of the plurality of phases is executed without prior outcome data for the scenario of the initial phase.

2. The computer system as defined in claim 1 wherein the decision optimization module includes instructions to calculate an optimum combination of revenue maximization, profit maximization, cost minimization, return on investment maximization, and information gathering.

3. The computer system as defined in claim 2 wherein the decision optimization module receives, as input, output from the scenario outcome predicting module and output from the adaptive learning module.

4. The computer system as defined in claim 1 wherein the set of parameters for the initial phase includes demographic information, socio-economic information, market information, product information, or combinations thereof.

5. The computer system as defined in claim 1 wherein the set of parameters for subsequent phases of the plurality of iterative phases includes the outcome data from previous phases, demographic information, socio-economic information, market information, product information, product usage information, a sub-sample description, attributes of previous phases of the multi-channel campaign, or combinations thereof.

6. The computer system as defined in claim 1 wherein the adaptive learning module includes instructions to generate a test-marketing campaign for each of the plurality of iterative phases.

7. The computer system as defined in claim 6 wherein the test-marketing campaign includes sub-samples, and marketing drivers for each of the sub-samples.

8. The computer system as defined in claim 1 wherein the scenario outcome predicting module includes instructions to perform recipient response modeling and to predict recipient responses.

9. A multi-channel campaign planning method, comprising:
generating, by a scenario outcome predicting module, a scenario having a set of parameters for each channel of an initial phase of a multi-channel campaign and a predicted outcome for the scenario, the set of parameters excluding prior outcome data;
generating, by an adaptive learning module, a plurality of test campaigns for each channel of the initial phase of the multi-channel campaign based upon the generated scenario and predicted outcome for the scenario;
receiving, by a decision optimization module, the plurality of test campaigns and the scenario and predicted outcome for the scenario; and
determining, by the decision optimization module, an optimal deployment campaign for each channel of the initial phase based at least on the plurality of test campaigns;
wherein each of the modules include computer readable instructions embedded on a non-transitory, tangible memory device that are executable by a digital processor.

10. The method as defined in claim 9 wherein the determining of which of the plurality of test campaigns is the optimal deployment campaign includes calculating, by the decision optimization module, an optimum combination of revenue maximization, cost minimization, and information gathering.

11. The method as defined in claim 9, further comprising:
executing, by a campaign execution module, the optimal deployment campaign for each channel of the initial phase;
receiving outcome data, at the campaign execution module, about the optimal deployment campaign for each channel of the initial phase;
generating, by the scenario outcome predicting module, a second scenario having a second set of parameters for each channel of a second phase of the multi-channel campaign and a predicted outcome for the second scenario, the set of parameters including the outcome data; and
generating, by the adaptive learning module, a second plurality of test campaigns for each channel of the second phase of the multi-channel campaign based upon the second scenario and the predicted outcome for the second scenario.

12. The method as defined in claim 11, further comprising:
receiving, by the decision optimization module, the second plurality of test campaigns and the second scenario and outcome for the second scenario; and
determining, by the decision optimization module, which of the second plurality of test campaigns is an optimal second deployment campaign for each channel of the second phase.

13. The method as defined in claim 12 wherein a cycle time between the initial phase and the second phase ranges from 1 hour to 4 weeks.

14. The method as defined in claim 9, further comprising generating, by the adaptive learning module, an optimized learning component for each of the plurality of test campaigns.

15. The method as defined in claim 9 wherein at least one of the plurality of test-marketing campaigns include sub-samples of recipients, and different marketing drivers for each of the sub-samples of recipients.

16. The method as defined in claim 15, further comprising selecting, by the adaptive learning module, the different marketing drivers to maximize learning from outcome data received by each of the sub-samples of recipients.

17. The method as defined in claim 9, further comprising dynamically generating, by the modules, a database based on information i) generated by any of the modules, ii) received by any of the modules, or iii) combinations thereof.
